(19) United States
(12) Patent Application Publication
(10) Pub. No.: US 2026/0142450 A1
(43) Pub. Date: May 21, 2026

(54) POWER ELECTRONIC CONVERTER, ELECTRIC MOTOR DRIVE AND METHOD FOR OPERATING A POWER ELECTRONIC CONVERTER

(71) Applicant: Danfoss Power Electronics A/S, Grästen (DK)

(72) Inventor: Wulf-Toke Franke, Harrislee (DE)

(21) Appl. No.: 19/391,045

(22) Filed: Nov. 17, 2025

(30) Foreign Application Priority Data
Nov. 21, 2024 (DE) 102024134285.4

(51) Int. Cl. H02H 7/10; H02H 9/00; H02J 3/00; H02J 3/18

(52) U.S. Cl. CPC H02H 7/10; H02H 9/005; H02J 3/001; H02J 3/1892

(57) ABSTRACT

The present invention pertains to a power electronic converter, such as an inverter or converter, for an electric application such as a motor drive, electrolyzer or charger. The power electronic converter includes a DC link and an active front end (AFE) connected to grid via a filter and a grid board with a first inrush relay with a resistive device. The resistive device may be a resistor, more specifically an NTC resistor or a PTC thermistor. The grid board further includes a second inrush relay, wherein at least one of the inrush relays is controlled to engage or disengage during startup phase of the power electronic converter and during abnormal grid voltage conditions, such that the DC link is charged via the resistive device or by bypassing the resistive device, and such that the AFE is provided for boosting the DC link voltage to a save level and under controlled conditions. The invention also pertains to an electric motor drive according and a method for operating a power electronic converter.

### CROSS-REFERENCE TO RELATED APPLICATION

This application claims foreign priority benefits under 35 U.S.C. § 119 to German Patent Application No. 102024134285.4 filed on Nov. 21, 2024, the content of which is hereby incorporated by reference in its entirety.

### TECHNICAL FIELD

The present invention pertains to a power electronic converter, such as an inverter or converter, for an electric application such as a motor drive, an electrolyzer or a charger.

The present invention relates to the field of inverters and converters used for providing electric power to electronic applications such as electric motors from a grid power source. The present invention may relate to low harmonic or zero distortion drives (LHD, ZD) and renewable applications such as solar panels, wind turbines, fuel cells, power to X applications, and related fields like (fast) electric chargers and electric energy storage systems. Typically, active front ends (AFE) and PFCs at all power levels may be used in this context.

### BACKGROUND

Usually, AFEs are provided with a filter, such as an LCL filter. The LCL filter leads to continuous (reactive) current consumption that loads the inrush circuit while inrush relays are open. Under fault conditions of the grid, e.g. low grid voltage, the electric application such as a motor drive might not be able to start up since the required DC link voltage is not reached. With conventional start up strategies this level cannot be reduced, since otherwise a transient in the grid will lead to a surge current possibly destroying the AFE circuit. Instead, the motor drive stays in an uncontrolled stage, where the resistive device, such as an inrush resistor/thermistor, is loaded by the LCL filter and will overheat since it is typically designed to carry current only for a very short time. Such events can lower the reliability of the system, since grid faults may age the AFE or in some special cases even damage the electric application. In order to prevent this, the same start up and fault strategies as for passive rectifiers may be currently used.

### SUMMARY

The aim of the invention is to overcome this problem. This aim is reached by a power electronic converter according to claim 1, an electric motor drive according to claim 6 and a method for operating a power electronic converter according to claim 7. Advantageous embodiments of the invention are subject to the dependent claims.

According to claim 1, a power electronic converter, such as an inverter or converter, for an electric application such as a motor drive, an electrolyzer or a charger is provided. The power electronic converter comprises a DC link and an active front end (AFE) connected to grid via a filter and a first inrush relay with a resistive device such as a resistor, an NTC resistor or a PTC thermistor and a second inrush semiconductor or relay. According to the invention, at least one of the inrush relays is controlled to engage or disengage during a startup phase of the power electronic converter and during an abnormal grid voltage condition, such that the DC link is charged via the resistive device or by bypassing the resistive device, and such that the AFE is provided for boosting the DC link voltage to a save level and under controlled conditions. In particular, the two inrush relays may both remain open in a first stage. After an adjustable time interval, the first inrush relay maybe closed and after another time interval the second inrush relay may be closed to control the total power input into the AFE. The inrush relays may be provided on a grid board or integrated within a different board, a coil box or they may be provided floating as discrete cable connected elements.

The basic idea of the invention is therefore that the AFE is utilized as early as possible to boost the DC link voltage in a controlled manner. In that way the relays of the inrush circuits can be closed within seconds and the inrush resistive device or inrush resistors will never be overloaded.

During voltage dips under normal operation the electric application can stay connected as long as at least one phase has a minimum voltage of e.g. 10% of nominal voltage. The advantage of the invention lies in the significant shortening of the startup process by several minutes and the avoidance of loss of control of the application.

In general, the present invention makes it possible to increase the robustness against grid faults and therefore the reliability of the electric application. The passive sequence of the start-up phase in which the electric application relies on normal grid conditions and a proper installation can be reduced to a level that is safe for the electric application under any conditions. Furthermore, cost and volume of the power electronic converter can be reduced since additional fuses and a third relay are not required.

With the proposed invention, the relays can be closed at much lower voltages while at the same time increasing the robustness against surge events. The proposed invention can also be applied for voltage dips during normal operation. Here, the electric application can stay in stand-by also for long dips or even grey outs, allowing the application to restart safely immediately as soon as the grid is back to normal voltage levels.

The present invention may be implemented entirely on a software level of the power electronic converter. The present invention makes the electric application more compact, cheaper and more reliable. The invention increases the up time of the electric application even during grid faults.

The present invention utilizes the additional options of an AFE such that additional effort for protection circuits and inrush circuits is required. With the present invention, the electric application becomes more robust against all challenges related to voltage dips and is also protected from some misuse by a user e.g. connecting the drive to a grid with a too low grid voltage.

In a preferred embodiment of the invention, the filter is an LCL or an LC filter. The filter may comprise components allocated to a dedicated coil box and/or an AFE power board.

In another preferred embodiment of the invention, the first inrush relay is provided at a first phase of the grid connection and the second inrush relay is provided at a second phase of the grid connection. A third phase of the grid connection may comprise a third inrush relay or no inrush relays at all and may provide a direct connection between the grid and the filter.

In another preferred embodiment of the invention, the inrush relays are provided for being controlled separately from each other via a control board.

In another preferred embodiment of the invention, the inrush relays are controlled via a relay board that is powered via a DC power connection to the AFE, in particular to the control board of the AFE.

The invention is also directed at an electric motor drive comprising a power electronic converter.

The invention is further directed at a method for operating a power electronic converter, the method comprising the steps of
monitoring the grid voltage for a normal grid voltage conditions and grid voltage dips;
boosting the DC link voltage if a grid voltage dip is detected, while the motor side inverter reduces its output power such that the DC-link voltage is maintained constant or increased; and setting the motor side inverter to a setpoint if the normal grid voltage is detected.

In a preferred embodiment of the invention, the method comprises the step of
controlling the inrush relays by means of a controller to engage or disengage during the startup phase of the power electronic converter and during the abnormal grid voltage conditions, such that the DC link is charged via the resistive device or by bypassing the resistive device without overloading the resistive device and that the DC link voltage is boosted.

In a preferred embodiment of the invention, the startup phase comprises a normal startup phase with a sequence of the following steps, preferably all and preferably in this given order:
The inrush relays are open by default while energising the application, the AFE and the motor side inverter are off;
applying the grid voltage to the Lcm terminals;
providing the supply voltage to the controller via a switch mode power supply (SMPS);
preferably pausing the startup phase for a defined time period for stabilizing the DC link voltage;
closing the inrush relays;
if the grid voltage is below typical value start boosting the DC link voltage by the AFEwhile the motor side inverter is turned off; and
if the grid voltage is within limits, turning on the motor side inverter and powering the power application with no power limitation.

In another preferred embodiment of the invention, the startup phase comprises an abnormal startup phase with a sequence of the following steps, preferably all and preferably in

this given order:
the inrush relays are open by default before energising the application, the AFE and the motor side inverter are off;
applying the grid voltage to the Lcm terminals;
providing the supply voltage to the controller via a switch mode power supply (SMPS);
preferably pausing the startup phase for defined time period for stabilizing the DC
link voltage;
detect an abnormal grid voltage
closing the inrush relays (1, 2);
start boosting the DC link voltage by the AFE immediately while the motor side inverter is turned off;
depending on grid voltage conditions, turning on the motor side inverter and powering the power application with the power limitation; and
detect normal grid voltage conditions, turning on the motor side inverter and powering the power application without the power limitation.

In another preferred embodiment of the invention, when during normal operation abnormal grid voltage conditions occur, the protected startup sequence comprises the following steps, preferably all and preferably in this given order:
a—the power application is running or in stand-by according to its current setpoint
b—detecting of the abnormal grid voltage conditions, such as a grid voltage dip
c—the AFE starts boosting immediately limited by the max. current rating, simultaneously the motor side inverter reduces the power to ensure that the DC-link voltage is constant or increased
d—when the grid voltage becomes normal (i.e. comes back to a normal value), it typically has an overvoltage, due to the high DC-link voltage, the resulting inrush current is limited to a safe level due to the high DC-link voltage
e—the motor side inverter can immediately go back to the setpoint.

### BRIEF DESCRIPTION OF THE DRAWINGS

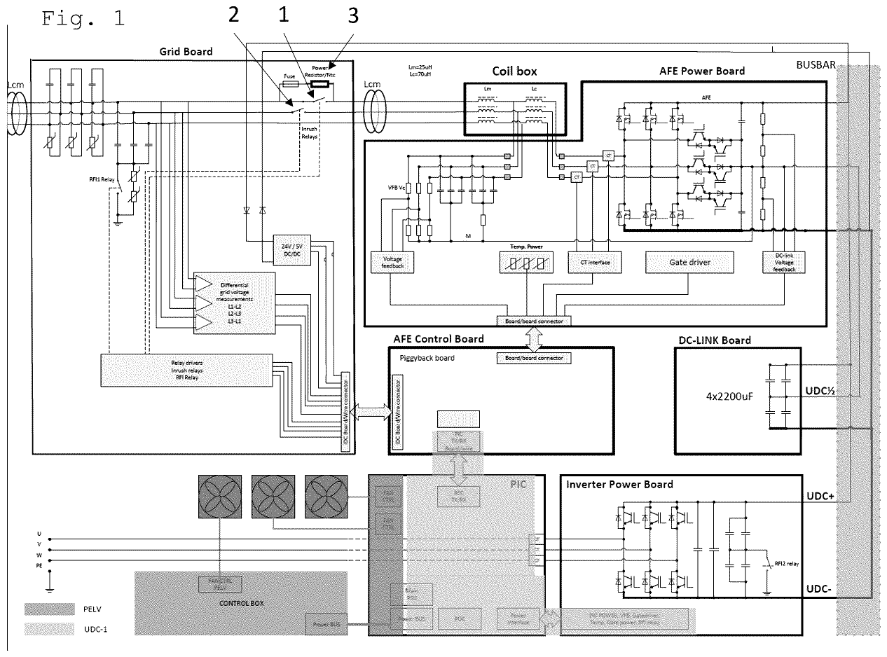

Further details and advantages of the invention are described with reference to FIG. 1, showing a circuit diagram of the present invention's power electronic converter.

### DETAILED DESCRIPTION

The circuit diagram of FIG. 1 shows the schematic of the present invention's power electronic converter, with the grid at Lcm on the left side and the DC link on the right side, indicated by the busbar. The AFE or rather the AFE power board is connected to grid via a filter indicated by the coil box and via a grid board. The grid board comprises a first inrush relay 1 with a parallel resistive device 3 such as a resistor, NTC resistor or PTC thermistor and a second inrush relay 2. The resistive device 3 may be arranged in series with a fuse. At least one of the inrush relays 1, 2 is controlled to engage or disengage during startup phase of the power electronic converter and during abnormal grid voltage conditions, such that the DC link is charged via the resistive device 3 or by bypassing the resistive device 3. The AFE may hence be provided for boosting the DC link voltage to a save level and under controlled conditions.

With a conventional start up sequence, typically all relays are opened first and the DC link is charged by the inrush resistors. The relays stay open until the DC link voltage reaches its minimum value of e.g. 530 V corresponding to a grid voltage of 380 V by passive rectification. The SMPSs and control unit starts up and the relays are closed. For abnormal conditions of the grid, e.g. a low grid voltage at e.g. 300 V providing a DC link voltage of only 424 V, the relays stay open to protect the electric application from any transient events. For passive front ends as rectifiers this is not problematic since no LCL filter caps are in the system and the inrush resistors are not significantly loaded. The electric application can stay in this condition for ever in theory.

With an AFE, the filter capacitors are typically selected to reduce the system cost, the size and the weight. Since these capacitors are connected to mains after the inrush circuit, they are permanently charged and discharged due the AC voltage of the grid. The resulting current through the inrush resistor is higher by a significant factor e.g. 8 to 30 times compared to a passive front end. Since the losses in the inrush resistor increase quadratically with the current, they need to be dimensioned by a factor of e.g. 50 to 1000 larger than for passive rectifiers to

keep the electric application running continuously in this stage. This is not a practical option due to losses, size and cost issues. Alternatively, the capacitors could be disconnected by relays or a third relay could be implemented that disconnects the electric application completely under such conditions. However, this approach also impacts costs and size negatively.

The present invention uses the fact that the AFE can boost the grid voltage to any DC link voltage, further SMPS start up at e.g. only 300 Vdc corresponding to a grid voltage of 212 Vac. According to the invention, in case the grid voltage is e.g. between 212 V and 380 V, the

DC link voltage is boosted to 530 V or even 700 V. Only now the relays 1, 2 can be closed. Even if the grid voltage comes suddenly back it will not lead to a surge current through the AFE since the DC link voltage is at least as high as in normal conditions and prevents the grid voltage from inducing any surge current flow. The additional boost to e.g. 700 V may be advantageous since under such conditions the voltage often comes back at an excessive level

and a resulting surge event can be prevented or at least significant reduced, thereby adding lifetime to the electric application. LHD drives operated in a region below e.g. 212 Vac grid voltage may not be in critical condition, since the currents through the capacitors and inrush circuit 3 are low enough to prevent overheating of the resistors. As long the AFE is in boost mode, the motor side inverter should be turned-off to prevent overloading of the AFE switches.

Voltage dips of the grid during normal operation can happen in several ways. Short deep dips down to zero Volt may occur along dips with e.g. 80% nominal grid voltage and anything between these extremes. In case of voltage dips during normal operation any drive will coast since there is now power to drive the electric application. Depending on the dip, the electric application will continue operation immediately after the voltage is back. However, if the DC link voltage goes below e.g. 530 V, the electric application will shut down completely and a complete new start is required. With an AFE and at least a very small grid voltage on minimum one of the phases, the electric application can be kept powered up and a restart can be avoided. Further, all communications stay alive and with a certain amount of grid voltage derated operation of the electric application is possible.

The following sequences exemplify the operation of the present invention's power electronic converter.

A normal start up sequence of the power electronic converter may comprise the following steps:
The Inrush relay is open
The Grid Power Voltage is applied to the Lcm terminals,
The SMPS (Switch Mode Power Supply) is providing a supply voltage to the Control unit(s),
The Motor side inverter is kept off,
Optional: Wait some seconds, to let the DC Link voltage stabilize,
The Inrush relay is closed,
Boost the DC link voltage by the AFE a bit (e.g. 2%), the motor side inverter is off,
The motor side Inverter is active and the motor can drive without a power limitation

A protected startup sequence of the power electronic converter may comprise the following steps:
a. The Inrush relay is open
b. The Grid Power Voltage is applied to the Lcm terminals,
c. The SMPS (Switch Mode Power Supply) is providing a supply voltage to the Control unit(s),
d. Motor side inverter is kept off,
e. A voltage drop on the grid occurs
f. The Inrush relay is closed,
g. Boost the DC link voltage (e.g. 2% above nominal rectified grid voltage) by the AFE, the motor side inverter is off,
h. The Motor side Inverter is active and the motor can drive without a power limitation.

Under abnormal grid voltage condition such as a voltage dip, the power electronic converter may be operated at a sequence comprising the following steps:
a. The inrush relays are closed and the power electronic converter is running at its setpoint
b. The grid voltage dips
c. The AFE starts boosting immediately limited by the max. current rating, simultaneously the motor side inverter reduces power to ensure that the dc-link voltage is at least constant or even more advance increased.
d. When the grid voltage comes back, it typically has an overvoltage, due to the high dc link voltage, the resulting inrush current is limited to a safe level due to the high DC link voltage
e. The motor side inverter can immediately go back to a setpoint. (no need to restart the drive)

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A power electronic converter, such as an inverter or converter, for an electric application such as a motor drive, an electrolyzer or a charger, comprising a DC link and an active front end (AFE) connected to a grid via a filter and a first inrush switch such as a semiconductor or a relay with a resistive device such as a resistor, an NTC resistor or a PTC thermistor and a second inrush semiconductor or relay, wherein at least one of the inrush relays is controlled to engage or disengage during a startup phase of the power electronic converter and during an abnormal grid voltage condition, such that the DC link is charged via the resistive device or by bypassing the resistive device, such that the AFE is provided for boosting the DC link voltage to a save level and under controlled conditions.

2. The power electronic converter according to claim 1, wherein the filter is an LCL or an LC filter.

3. The power electronic converter according to claim 1, wherein the first inrush relay is provided at a first phase of the grid connection and the second inrush relay is provided at a second phase of the grid connection.

4. The power electronic converter according to claim 1, wherein the inrush relays are provided for being controlled separately from each other via a control board.

5. The power electronic converter according to claim 1, wherein the inrush relays are controlled via a relay board that is powered via a DC power connection to the AFE, in particular to the control board according to the previous claim.

6. An electric motor drive comprising the power electronic converter according to claim 1.

7. A method for operating the power electronic converter according to claim 1, comprising the following steps:
monitoring the grid voltage for a normal grid voltage conditions and grid voltage dips;
boosting the DC link voltage if a grid voltage dip is detected, while the motor side inverter reduces its output power such that the DC-link voltage is maintained constant or increased; and
setting the motor side inverter to a setpoint if the normal grid voltage is detected.

8. The method according to claim 7, wherein the method comprises the step of
controlling the inrush relays by means of a controller to engage or disengage during the startup phase of the power electronic converter and during the abnormal grid voltage conditions, such that the DC link is charged via the resistive device or by bypassing the resistive device without overloading the resistive device and that the DC link voltage is boosted.

9. The method according to claim 7, wherein the startup phase comprises a normal startup phase with a sequence of the following steps, preferably all and preferably in this given order:
the inrush relays are open by default before energising the application, the AFE and the motor side inverter are off;
applying the grid voltage to the Lcm terminals;
providing the supply voltage to the controller via a switch mode power supply (SMPS);
preferably pausing the startup phase for a defined time period for stabilizing the DC
link voltage;
closing the inrush relays;
if the grid voltage is below typical value start boosting the DC link voltage by the AFE while the motor side inverter is turned off; and
if the grid voltage is within limits, turning on the motor side inverter and powering the power application with no power limitation.

10. The method according to claim 7, wherein the startup phase comprises an abnormal startup phase with a sequence of the following steps, preferably all and preferably in this given order:
the inrush relays are open by default before energising the application, the AFE and the motor side inverter are off;
applying the grid voltage to the Lcm terminals;
providing the supply voltage to the controller via a switch mode power supply (SMPS);
preferably pausing the startup phase for defined time period for stabilizing the DC link voltage;
detect an abnormal grid voltage
closing the inrush relays;
start boosting the DC link voltage by the AFE immediately while the motor side inverter is turned off;
depending on grid voltage conditions, turning on the motor side inverter and powering the power application with the power limitation; and
detect normal grid voltage conditions, turning on the motor side inverter and powering the power application without the power limitation.

11. The method according to claim 7, wherein when during normal operation abnormal grid voltage conditions occur, the protected startup sequence comprises the following steps, preferably all and preferably in this given order:
A—the power application is running or in stand-by according to its current setpoint
b—detecting of the abnormal grid voltage conditions, such as a grid voltage dip
c—the AFE starts boosting immediately limited by the max. current rating, simultaneously the motor side inverter reduces the power to ensure that the DC-link voltage is constant or increased
d—when the grid voltage becomes normal, it typically has an overvoltage, due to the high DC-link voltage, the resulting inrush current is limited to a safe level due to the high DC-link voltage
e—the motor side inverter can immediately go back to the setpoint.
